(19) United States
(12) Patent Application Publication
(10) Pub. No.: US 2006/0190655 A1
(43) Pub. Date: Aug. 24, 2006

(54) Apparatus and method for transaction tag mapping between bus domains

(75) Inventors: Mark E. Kautzman, Colchester, VT (US); Clarence Rosser Ogilvie, Huntington, VT (US); Charles S. Woodruff, Charlotte, VT (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/064,567

(22) Filed: Feb. 24, 2005

(51) Int. Cl. G06F 13/36

(52) U.S. Cl. 710/306; 710/315

(57) ABSTRACT

An apparatus and method to provide tag mapping between bus domains across a bus bridge. The preferred embodiments provide a simple tag mapping design while maintaining unique IDs for all outstanding transactions for an overall increase in computer system performance. The preferred embodiment is a bus bridge between a GPUL bus for a GPUL PowerPC microprocessor from International Business Machines Corporation (IBM) and an output high speed interface (MPI bus). In preferred embodiments, the transaction mapping logic ensures that transactions generated by any logical unit (CPU) appear to originate from a single logical unit.

### RELATED APPLICATIONS

The present application is related to the following applications, which are incorporated herein by reference:

“Method and System for Ordering Requests at a Bus Interface”, Ogilvie et al., Serial No.______, co-filed herewith (IBM Docket No. ROC920040299US1);

“Data Ordering Translation Between Linear and Interleaved Domains at a Bus Interface”, Horton et al., Serial No.______, co-filed herewith (IBM Docket No. ROC920040300US1);

“Method and System for Controlling Forwarding or Terminating of a Request at a Bus Interface Based on Buffer Availability”, Ogilvie et al., Serial No.______, co-filed herewith (IBM Docket No. ROC920040301US1);

“Computer System Bus Bridge”, Biran et al., Serial No.______, co-filed herewith (IBM Docket No. ROC920040302US1);

“Transaction Flow Control Mechanism for a Bus Bridge”, Ogilvie et al., Serial No.______, co-filed herewith (IBM Docket No. ROC920040304US1);

“Pipeline Bit Handling Circuit and Method for a Bus Bridge”, Drehmel et al., Serial No.______, co-filed herewith (IBM Docket No. ROC920040305US1); and

“Computer System Architecture”, Biran et al., Serial No. ______, co-filed herewith (IBM Docket No. ROC920040316US1).

### BACKGROUND OF THE INVENTION

1. Technical Field

This invention generally relates to computer bus systems with multiple processors, and more specifically relates to an apparatus and method for tag mapping transactions between buses in a computer system.

2. Background Art

Many high speed computer systems have more than one central processing unit (CPU) to increase the speed and performance of the computer system. The CPUs in the system are interconnected by one or more buses. Each of the CPU's and possibly other control devices are typically separate logical units on the bus. In some computer systems, the logical units which generate transactions create a tag to uniquely identify a transaction as well as associate the data portion with the command portion of that transaction. This tag typically includes information identifying the logical unit which generated the command, as well as a transaction ID to differentiate the transaction from any other outstanding transactions.

Bus protocol specifications may define different schemes for tagging bus transactions. Transactions which cross from one bus domain to another bus domain must have their transaction tags converted to the format of the other domain. Prior art solutions to allow this domain crossing might use tag generation units to produce and track unique tag numbers. These designs might include CAMs or other complex design elements.

The preferred embodiments avoid the complex structures of the prior art, significantly reducing overall logic complexity. The transaction mapping logic provides this mapping function while maintaining unique IDs for all outstanding transactions.

### DISCLOSURE OF INVENTION

Preferred embodiments of the invention provide an apparatus and method for tag mapping between bus domains across a bus bridge, such as a bridge between two high speed computer buses. The preferred embodiments provide a simple tag mapping design while maintaining unique IDs for all outstanding transactions for an overall increase in computer system performance. The preferred embodiment is a bus bridge between a GPUL bus for a GPUL PowerPC microprocessor from International Business Machines Corporation (IBM) and an output high speed interface (MPI bus).

In preferred embodiments, the transaction mapping logic ensures that transactions generated by any logical unit (CPU) appear to originate from a single logical unit.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a computer system in accordance with the preferred embodiments;

FIG. 2 is a block diagram of the bus transceiver shown in the computer system of FIG. 1;

FIG. 3 is a block diagram of the API to MPI Bridge (AMB) in accordance with the preferred embodiments;

FIG. 4 is a block diagram showing the AMB and the API and MPI domains to illustrate the tag mapping between bus domains in accordance with the preferred embodiments;

FIG. 5 is a diagram of the API to MPI transaction ID mapping in accordance with the preferred embodiments; and

FIG. 6 is a flow diagram of a method for transaction ID mapping in accordance with the preferred embodiments.

### BEST MODE FOR CARRYING OUT THE INVENTION

Overview

Embodiments herein provide a method and apparatus for tag mapping between bus domains across a bus bridge between two high speed computers. The preferred embodiment is a bus bridge between a GPUL bus for a GPUL PowerPC microprocessor from International Business Machines Corporation (IBM) and an output high speed interface (MPI bus). Published information is available about the GPUL processor 110 and the GPUL bus 130 from various sources including IBM's website. This section provides an overview of these two buses.

API Bus

The API bus is sometimes referred to as the PowerPC970FX interface bus, GPUL Bus or the PI bus (in the PowerPC's specifications). This document primarily uses the term API bus, but the other terms are essentially interchangeable. The API bus consists of a set of unidirectional, point-to-point bus segments for maximum data transfer rates. No bus-level arbitration is required. An Address/Data (AD) bus segment, a Transfer Handshake (TH) bus segment, and a Snoop Response (SR) bus segment exist in each direction, outbound and inbound. The terms packet, beat, master, and slave are defined in the following paragraphs.

Data is transferred across a bus in beats from master to slave. A beat is a timing event relative to the rising or falling edge of the clock signal. Nominally there are two beats per clock cycle (one for the rising edge and one for the falling edge).

A packet is the fundamental protocol data unit for the API bus. A non-null packet consists of an even number of data elements that are sequentially transferred across a source-synchronous bus at the rate of one element per bus beat. The number of bits in each data element equals the width of the bus. Packets are used for sending commands, reading and writing data, maintaining distributed cache coherency, and transfer-protocol handshaking.

A sender or source of packets for a bus segment is called a master and a receiver or recipient is called a slave. For example, on an outbound processor bus segment, the north bridge is the slave and the processor is the master. On an inbound processor bus segment, the north bridge is the master and the processor is the slave. Four basic packet types are defined: null packets, command packets, data packets, and transfer-handshake packets. Non-null packet lengths are always an even number of beats. Null packets are sent across the address/data bus. For the null packet all bits are zero. Null packets are ignored by slave devices. Command packets are sent across the address/data bus. These are further partitioned into three types: read/command packets, write-command packets, and coherency-control packets. Data packets are also sent across the address/data bus. These are further partitioned into two types: read-data packets and write-data packets. A write-data packet immediately follows a write-command packet. A read-data packet is sent in response to a read-command packet or a cache-coherency snoop operation. A data read header contains the address of the command, the command type, and transfer details.

Transfer-handshake packets are sent across the transfer handshake bus. This packet is issued to confirm receipt and indicate the condition of the received command packet or data packet. Condition encoding includes Acknowledge, Retry, Parity Error, or Null/Idle. A transfer-handshake packet is two beats in length.

The API bus includes an Address/Data (AD) bus segment, a Transfer Handshake (TH) bus segment, and a Snoop Response (SR) bus segment in each direction, outbound and inbound. The Transfer Handshake bus sends transfer-handshake packets which confirm command or data packets were received on the Address/Data bus. The Transfer Handshake bus consists of one 1-bit outbound bus segment (THO) and one 1-bit inbound bus segment (THI). Every device issuing a command packet, data packet, or reflected command packet to the Address/Data bus receives a transfer-handshake packet via the Transfer Handshake bus some fixed number of beats after issuing the command or data packet. Each Transfer Handshake bus segment sends transfer packets for command and data packets transferred in the opposite direction. That is, the outbound Transfer Handshake bus sends acknowledge packets for the command and data packets received on the inbound AD bus. There is no dependency or relationship between packets on the outbound Address/Data bus and the outbound Transfer Handshake bus.

A transfer-handshake packet might result in a command packet being reissued to the bus due to a command queue data buffer full condition. A transaction remains active until it has passed all response windows. For write transactions this includes the last beat of the data payload. Since commands might be retried for queue or buffer full conditions, transactions that must be ordered cannot be simultaneously in the active state. A write transaction issued by the processor can be retried. There are two transfer-handshake packets issued by the slave for a write transaction. The first packet is for the write-command packet and the second for the write-data packet. For read transactions, the processor will not retry inbound (memory to processor) transfers. Reflected commands, i.e., snoop requests (inbound from North Bridge to processor), cannot be retried. This is necessary to ensure a fixed snoop window is maintained.

The Snoop Response bus supports global snooping activities to maintain cache coherency. This bus is used by a processor to respond to a reflected command packet received on the API bus. The Snoop Response bus consists of one 2-bit outbound bus segment (SRO) and one 2-bit inbound bus segment (SRI). The bus segments can detect single bit errors.

API Bus Summary

The address portion of the bus is 42 bits wide and is transferred in 2 beats. Data is 64 bits wide and transferred across a bus in a maximum of 4 bytes/beats from master to slave or slave to master. The API bus has a unified command phase and data phase for bus transactions. A single tag is used to identify an entire bus transaction for both command phase and data phase. Tags are unique when bus transactions are outstanding. Each command tenure contains a target slave address, the master's requestor unit id, the transfer type, the transfer size, an address modifier, and transaction tag for the entire transaction. The size of the single transaction tag is m-1 bits, with respect to the MPI bus command destination tag.

The API bus supports the modified intervention address snoop response protocol which effectively allows a master device to request and obtain a cache line of 128 bytes from another master device. Bus transactions can have three phases: a command phase, snoop phase and a data phase. Command only transactions are possible, which include a command phase and snoop phase. Cache line coherency is supported by reflecting commands to other master and slave devices attached to the bus coupled with a bus snooping protocol in the snoop phase. The API bus supports the modified intervention address snoop response protocol, which allows a master device to request a cache line from another master device.

The MPI Bus and Comparison to the API Bus

The MPI bus is a microprocessor bus of equal or higher performance than the API bus. The MPI bus also supports attachment of multiple master and slave devices. The address bus is 42 bits wide and is transferred in 1 beat. Data is transferred across a bus in a maximum 16 bytes/beats from master to slave or slave to master. The data bus is 128 bits wide. Each complete bus transaction is split into unique tagged command transaction phases and data transaction phases, which is different from unified transaction on the API bus.

There are a total of three tags on the MPI bus that are used to mark complete bus transactions. Two are used in the command phase the third is used in the data phase. Each command phase uses a destination tag and response acknowledge tag. The command destination tag (grttag) indicates the unique command for which the response is destined. The size of this command destination tag is m bits, and is one bit larger that the command transaction tag on the API bus. The response acknowledge tag (gratag) indicates the unique unit which responds to the issued command. The data transaction tag (dtag) indicates the unique data transfer. Tags are unique when bus transactions are outstanding. Since the data phase has its own unique dtag, the data phase of one transaction may finish out of order with respect to the data phase of another transaction.

Each command contains a target slave address, the requestor's unit id, transfer type, transfer size, an address modifier, and the command destination tag. The command phase is composed of a request tenure, reflected command tenure, and then a global snoop response tenure. The request tenure issues the command, with a destination tag. The reflected command tenure, reflects the command on the bus and then returns a master slave snoop response (gresp) to the MPI.

The global snoop response tenure provides a combined response from all units on the bus via the CBI, with the original destination tag and the response acknowledge tag (gratag). The data transaction phase is composed of the data request tenure and the data transfer tenure. The data transaction phase occurs independently after the command phase is completed if data transfer is required. In the data request tenure, a master requests to transfer data and it waits until it gets a grant from the target slave device. The data transfer tenure begins after the grant is received. The master provides the data transaction tag, and the data transfers while the data valid signal is active.

The MPI bus contains a credit mechanism to indicate availability of available transaction buffer resources. This credit mechanism is used by MPI masters to pace their issue of new command transactions.

### DESCRIPTION OF THE PREFERRED EMBODIMENTS

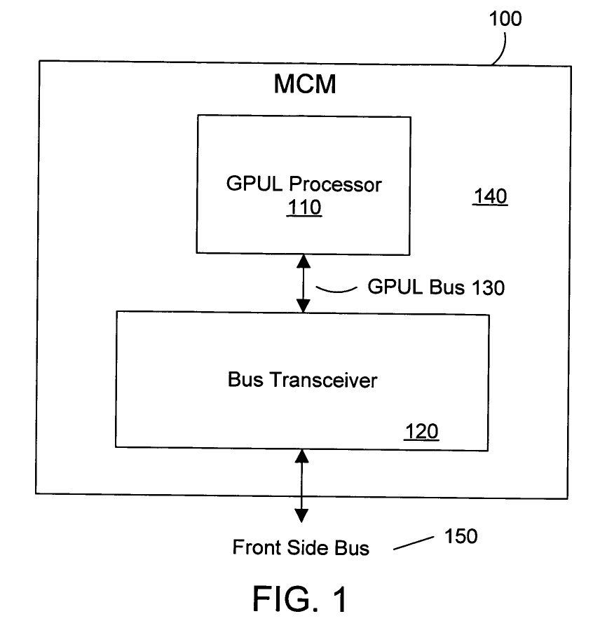

FIG. 1 illustrates a block diagram of a computer processor system 100 according to a preferred embodiment. The computer processor system 100 includes a Giga-Processor Ultralite (GPUL) 110 for the central processing unit. The GPUL is connected to an ASIC bus transceiver 120 with a GPUL bus 130. The illustrated embodiment shows a single GPUL processor 110 but it is understood that multiple processors could be connected to the GPUL bus 130. The GPUL 110 and the bus transceiver 120 are interconnected on a Multi-Chip Module (MCM) 140. In other embodiments (not shown) the processor(s) and the transceiver are integrated on a single chip. Communication with the computer system 100 is provided over a Front Side Bus (FSB) 150.

In the preferred embodiment, the GPUL 110 is a prior art processor core from International Business Machines Corporation (IBM) called the IBM PowerPC970FX RISC microprocessor. The GPUL 110 provides high performance processing by manipulating data in 64-bit chunks and accelerating compute-intensive workloads like multimedia and graphics through specialized circuitry known as a single instruction multiple data (SIMD) unit. The GPUL 110 processor incorporates a GPUL bus 130 for a communications link. The GPUL bus 130 is also sometimes referred to as the API bus. In the illustrated embodiment, the GPUL bus 130 is connected to a bus transceiver 120.

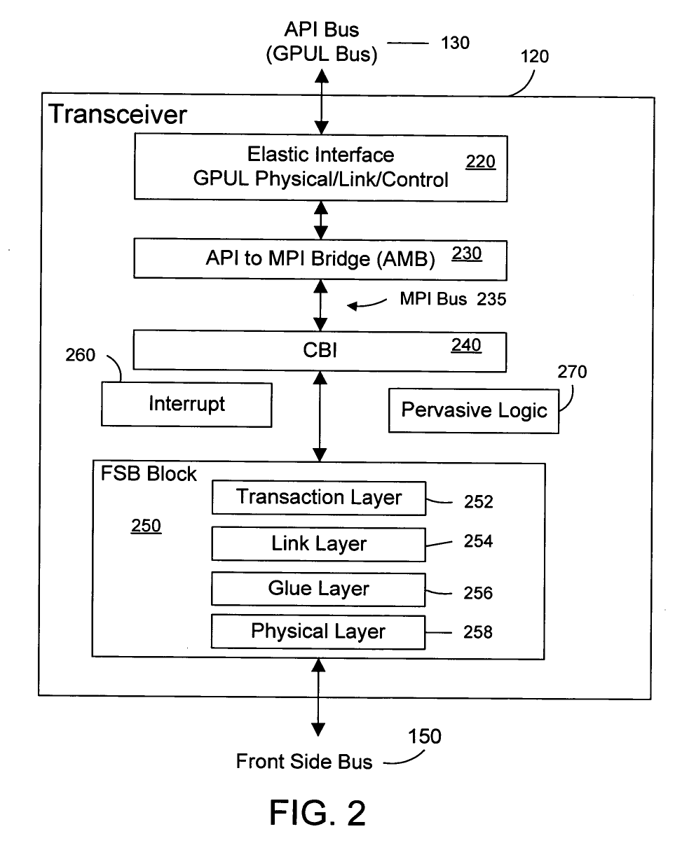

FIG. 2 illustrates a block diagram of the bus transceiver 120 according to preferred embodiments. The bus transceiver 120 includes an elastic interface 220 that is the physical/link/control layer for the transceiver connection to the GPUL processor over the API bus 130. The elastic interface is connected to the API to MPI Bridge (AMB) 230. The AMB 230 is a bus bridge that provides protocol conversion between the MPI bus 235 and the API bus 130 protocols. The MPI bus 235 connects the AMB 230 to the Common Bus Interface (CBI) block 240. The CBI connects to the Front Side Bus (FSB) block 250. The FSB block provides I/O connections for the bus transceiver 120 to the Front Side Bus (FSB) 150. The FSB block 250 includes a transaction layer 252, a link layer 254, a glue layer 256 and a physical layer 258. The bus transceiver 120 also includes an interrupt block 260, and a pervasive logic block 270. Each of these blocks in bus transceiver 120 is described further in the co-filed applications referenced above.

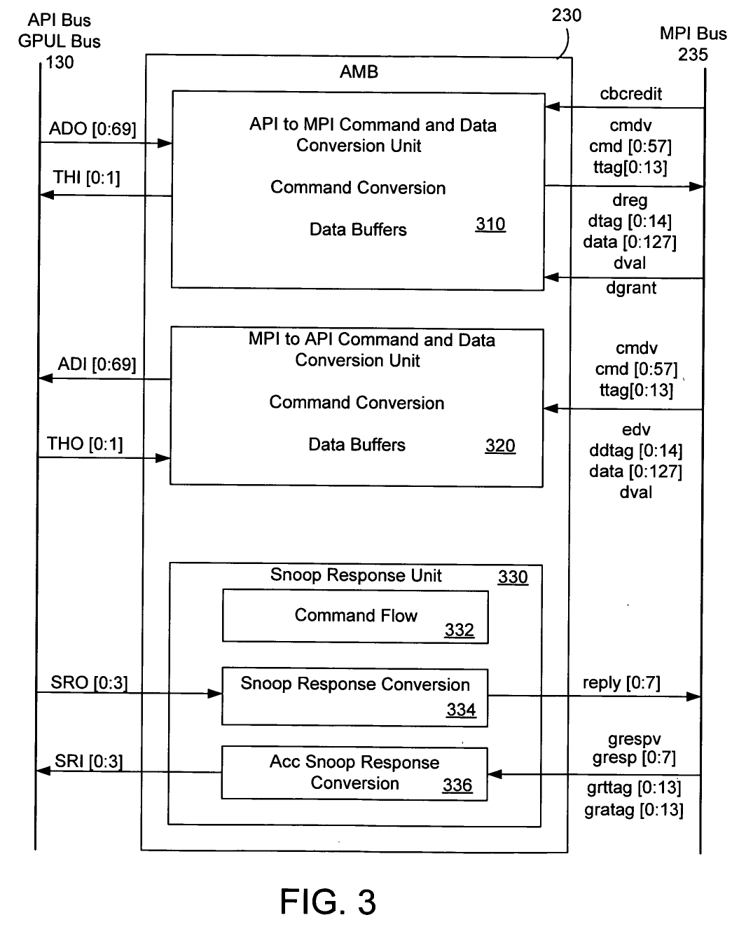

FIG. 3 further illustrates the AMB 230. The AMB 230 is the conversion logic between the API bus 130 and MPI bus 235. The AMB 230 transfers commands, data, and coherency snoop transactions back and forth between the elastic interface 220 and the CBI 240 in FIG. 2. The AMB is made up of three units: the API to MPI command and data conversion unit 310, the MPI to API command and data conversion unit 320 and the snoop response unit 330. The primary function of each unit is to convert the appropriate commands, data, and snoop responses from the API bus to the MPI bus and from the MPI bus to the API bus.

Tag Mapping

In the computer system described above, the CPUs are logical units which generate transactions. A tag is created by the logical units to uniquely identify the transaction. The tag identifies the logical unit (CPU) which generated the command, as well as a transaction ID to differentiate the transaction from other outstanding transactions. In the preferred embodiment computer system described above, the bus protocol specifications define different schemes for tagging bus transactions. Transactions which cross from one bus domain to another bus domain must have their transaction tags converted to the format of the other domain. The transaction mapping according to the preferred embodiments provides this conversion function while maintaining unique IDs for all outstanding transactions.

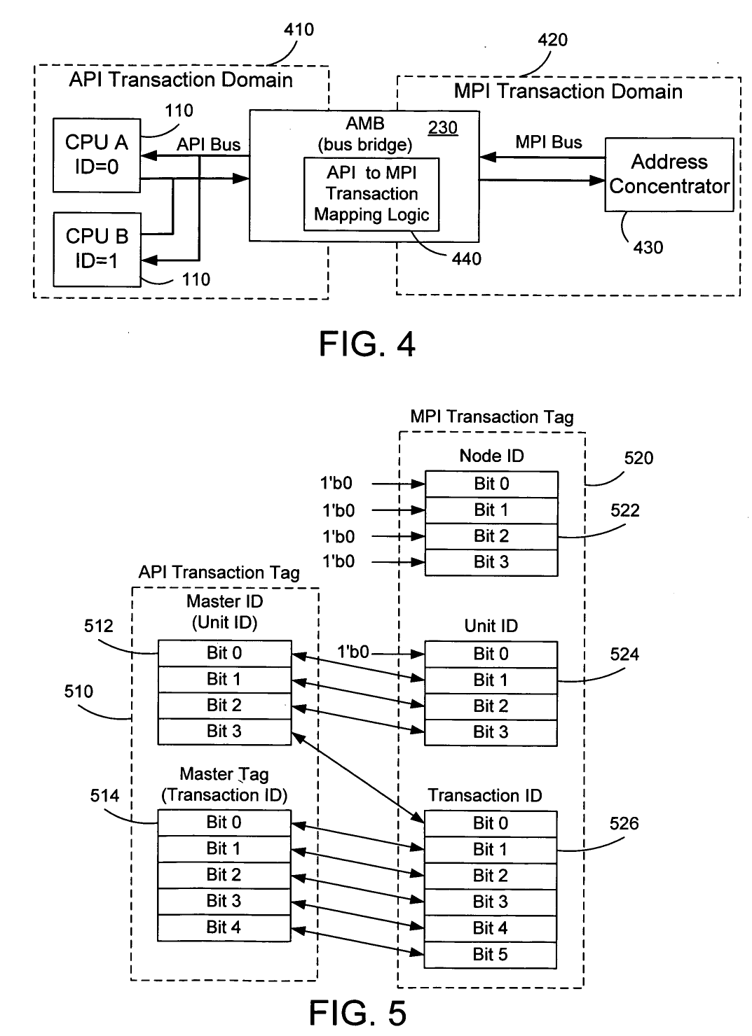

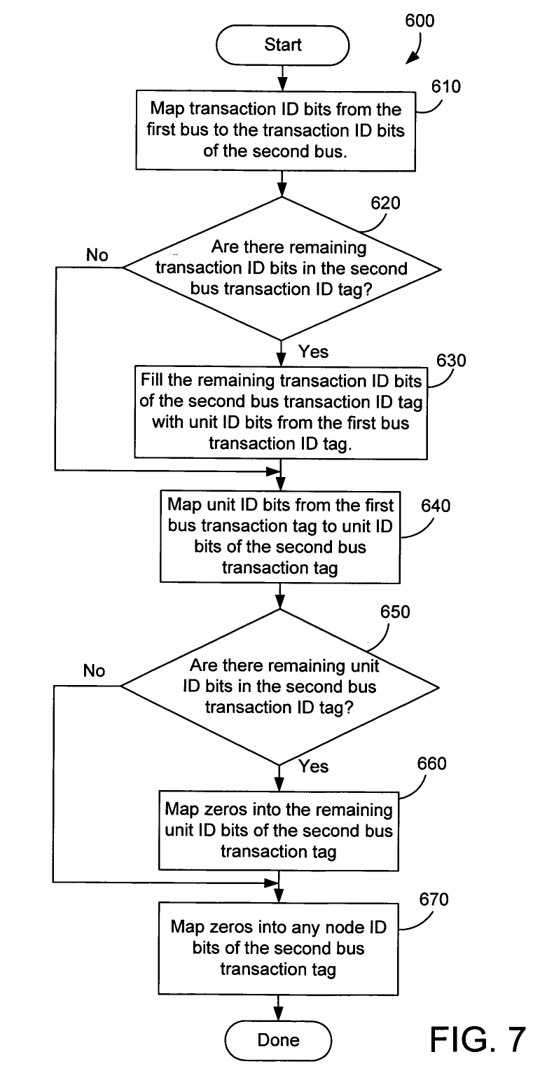

FIG. 4 shows a block diagram according to a preferred embodiment. The API transaction domain 410 includes one or more processors 110 as described above with reference to FIG. 1. The processors 110 communicate with the AMB 230 (also shown in FIG. 2) which is located in bus transceiver 120 (shown in FIG. 1). The MPI transaction domain 420 includes the address concentrator 430 which resides in the CBI 240 (shown in FIG. 2). The AMB 230 includes API to MPI transaction mapping logic 440 described further below with reference to FIG. 5.

FIG. 5 illustrates the API to MPI transaction mapping which is accomplished with the transaction mapping logic 440 according to a preferred embodiment. The transaction mapping logic 440 is not show specifically, but it is understood that those skilled in the art could devise numerous ways to implement the mappings as shown using registers, shift registers and other common logic. The transaction mapping logic 440 converts between an API transaction tag 510 and a MPI transaction tag 520. In the API transaction domain, the API transaction tag includes an a 4-bit API Master ID (equivalent to the unit ID) field 512 and a 5-bit master tag field 514 (equivalent to the API transaction ID). The Master ID field 512 contains the ID of the CPU or any other API master which creates transactions. In the illustrated embodiment, CPU A has an ID=0, CPU B has and ID=1.

In the MPI transaction domain, the MPI transaction tag includes a node ID 522, a unit ID 524 and a transaction ID 526. The MPI node ID 522 is a 4-bit field and always equal to 0 for the preferred embodiment as described further below. The MPI unit ID 524 is a 4-bit field and the MPI Transaction ID 526 is a 6-bit field. The MPI Unit ID 524 contains the ID of the logical unit. In the preferred embodiment, three Unit IDs are reserved: 0 for the processor complex; 1, 2 and 3 for other logical units in the MPI domain.

Embodiments herein provide a one-to-one mapping of the API transaction tag and the MPI transaction tag to ensure the uniqueness of a transaction tag in one domain will be maintained in the other domain. By mapping one bit of the API Master ID field onto one bit of the MPIs Transaction ID field and inserting zero's into all MPI positions which are known to be unused , transaction tags can be mapped between the API and MPI domains as shown in FIG. 5.

In preferred embodiments, the transaction mapping logic ensures that transactions generated by any logical unit (CPU) appear to originate from a single logical unit. This is necessary in the preferred embodiment system since the address concentrator 430 in the MPI transaction domain 420 requires that all transactions originating from CPU A or CPU B must appear to come from a single functional unit. However, in the API transaction domain 410, each transaction is identified as belonging to either CPU A or CPU B. Thus, the illustrated mapping ensures that transactions generated by either of the CPUs in the API transaction domain 410 will appear to come from a single unit, as seen by the address concentrator 430 in the MPI transaction domain 420.

Table 1 shows the mapping for commands originating in the API domain. As seen by the Address Concentrator, all transactions appear to come from a single CPU complex. Table 2 shows the mapping for commands originating in the MPI domain. There are three logical units which can originate commands in the MPI domain (Logical Unit A, B, C). From the perspective of the CPUs in the API domain, it appears that there are 6 logical units (Logical Unit A0, A1, B0, B1, C0, C1).

TABLE 1
Mapping for all transactions originating in the API domain.

| API | | API | MPI | | |
|---|---|---|---|---|---|
| Master | API | Tag | Unit | MPI | |
| ID | Unit | Range | ID | Unit | MPI Transaction |
| (4 bits) | Name | (5 bits) | (4 bits) | Name | ID (6 bits) |
| 0000 | CPU A | 0000-1111 | 0000 | CPU | 000000-111111 |
| | | | | Complex | |
| 0001 | CPU B | 0000-1111 | 0000 | CPU | 100000-111111 |
| | | | | Complex | |

TABLE 2
Mapping for all transactions originating in the MPI domain.

| MPI Master | MPI Unit | MPI Tag | API Unit | API Unit | API Transaction |
|---|---|---|---|---|---|
| ID (4 bits) | Name | Range (5 bits) | ID (4 bits) | Name | ID (5 bits) |
| 0001 | Logical | 000000-011111 | 0010 | Logical | 00000-11111 |
| | Unit A | | | Unit A0 | |
| 0001 | Logical | 100000-111111 | 0011 | Logical | 00000-11111 |
| | Unit A | | | Unit A1 | |
| 0010 | Logical | 000000-011111 | 0100 | Logical | 00000-11111 |
| | Unit B | | | Unit B0 | |
| 0010 | Logical | 100000-111111 | 0101 | Logical | 00000-11111 |
| | Unit B | | | Unit B1 | |
| 0011 | Logical | 000000-011111 | 0110 | Logical | 00000-11111 |
| | Unit C | | | Unit C0 | |
| 0011 | Logical | 100000-111111 | 0111 | Logical | 00000-11111 |
| | Unit C | | | Unit C1 | |

FIG. 6 shows a method 600 according to embodiments of the present invention to convert transaction tags from a first domain to a second domain. First the transaction ID bits from the first bus transaction tag are mapped one-to-one to the transaction ID bits of the second bus 610. If there are remaining unmapped bits in the second transaction ID field (step 620=yes), then bits of the unit ID field of the first bus transaction tag are mapped to the remaining transaction ID bits of the second bus transaction tag 630. If there no remaining unmapped bits in the second transaction ID field (step 620=no), then the method 600 skips step 630 and proceeds to step 640. The method then maps unit ID bits one-to-one from the first bus transaction tag to the unit ID bits of the second bus transaction tag 640. If there are remaining unmapped bits in the unit ID field of the second bus transaction tag (step 650=yes), then zeros are mapped to the remaining unit ID bits of the second bus transaction tag 660. If there no remaining unmapped bits in the unit ID field of the second bus transaction tag (step 650=no), then method 600 skips step 660 and proceeds to step 670. The method then maps zeros to any node ID bits in the second bus transaction tag 670. The method is then done.

The embodiments described herein provide important improvements over the prior art. The preferred embodiments will provide the computer industry with a simple tag mapping design while maintaining unique IDs for all outstanding transactions for an overall increase in computer system performance. Furthermore, embodiments allow the transactions to appear to come from a single functional unit.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A transaction tag mapping circuit in a computer bus bridge between a first transaction tag on a first bus and a second transaction tag on a second bus comprising:
logic to map transaction ID bits from the transaction tag on the first bus to transaction ID bits of a transaction tag on the second bus; and
logic to map at least one unit ID bit from the transaction tag on the first bus to the transaction ID bits of the transaction tag on the second bus to provide a unique transaction ID from the first bus to the second bus.

2. The transaction tag mapping circuit of claim 1 wherein the transaction tags on the first bus appear on the second bus to come from a single functional unit.

3. The transaction tag mapping circuit of claim 1 further comprising logic to map unit ID bits from the transaction tag on the first bus to the unit ID bits of the transaction tag on the second bus; and
logic to fill any unmapped unit ID bits in the transaction tag on the second bus with zeros.

4. The transaction tag mapping circuit of claim 3 further comprising logic to fill any node ID bits in the transaction tag on the second bus with zeros.

5. The transaction tag mapping circuit of claim 3 wherein the first bus is an API bus.

6. The transaction tag mapping circuit of claim 3 wherein the second bus is a MPI bus.

7. The transaction tag mapping circuit of claim 3 wherein the first bus is an API bus the second bus is a MPI bus and wherein:
five bits of the API transaction ID and one bit of the API unit ID are mapped to the MPI transaction ID;
4 bits of the API unit ID are mapped to the MPI unit ID and a remaining bit of the MPI unit ID is set to zero; and
the node ID bits of the MPI transaction tag are set to zero.

8. The transaction tag mapping circuit of claim 1 wherein the first bus is an API bus.

9. The transaction tag mapping circuit of claim 1 wherein the second bus is a MPI bus.

10. A computer system with a transaction tag mapping circuit in a bus bridge between a first computer system bus and a second computer system bus comprising:
logic to map transaction ID bits from the transaction tag on the first computer system bus to the transaction ID bits of a transaction tag on the second computer system bus;
logic to map at least one unit ID bit from the transaction tag on the first computer system bus to the transaction ID bits of a transaction tag on the second computer system bus;
logic to map unit ID bits from the transaction tag on the first computer system bus to the unit ID bits of a transaction tag on the second computer system bus; and
logic to fill any unmapped unit ID bits in the transaction tag on the second computer system bus with zeros.

11. The computer system of claim 10 further comprising logic to fill any node ID bits in the transaction tag on the second computer system bus with zeros

12. The computer system of claim 10 wherein the transaction tags on the first bus appear on the second bus to come from a single functional unit.

13. The computer system of claim 10 wherein the first bus is an API bus.

14. The computer system of claim 10 wherein the first bus is a MPI bus.

15. The computer system of claim 10 wherein the first bus is an API bus the second bus is a MPI bus and wherein:
five bits of the API transaction ID and one bit of the API unit ID are mapped to the MPI transaction ID;
4 bits of the API unit ID are mapped to the MPI unit ID and a remaining bit of the MPI unit ID is set to zero; and
the node ID bits of the MPI transaction tag are set to zero.

16. A method for mapping transaction tags between a transaction tag of a first bus having a transaction ID field and a unit ID field and a transaction tag of a second bus having a transaction ID field, and a unit ID field, the method comprising the steps of:
mapping transaction ID bits from the first bus transaction tag to transaction tag ID bits of the second bus transaction tag;
filling a remainder of the transaction ID field of the second bus with unit ID bits from the transaction tag of the first bus;
mapping the remainder of the unit ID bits from the first bus transaction tag to the unit ID bits in the second bus; and
placing zeros in any remaining bits of the unit ID bits in the second bus transaction tag.

17. The method of claim 15 wherein the transaction tag of the second bus further comprises a node ID field and the method further comprises the step of placing zeros in the node ID bits in the second bus transaction tag.

18. The method of claim 15 wherein the first bus is an API bus.

19. The method of claim 15 wherein the second bus is a MPI bus.

20. The method of claim 15 wherein the transaction tags on the first bus appear on the second bus to come from a single functional unit.
